(19) United States
(12) Patent Application Publication
(10) Pub. No.: US 2026/0001618 A1
(43) Pub. Date: Jan. 1, 2026

(54) DRIVE DEVICE FOR AN ELECTRIC BICYCLE AND ELECTRIC BICYCLE

(71) Applicant: Porsche eBike Performance GmbH, Ottobrunn (DE)

(72) Inventor: Stephan Happ, Munich (DE)

(21) Appl. No.: 18/880,524

(22) PCT Filed: Jun. 6, 2023
(86) PCT No.: PCT/EP2023/065123

§ 371 Date: Dec. 31, 2024

(30) Foreign Application Priority Data
Jul. 6, 2022 (DE) 10 2022 116 830.1

(51) Int. Cl. B62M 6/55; B62M 9/00; B62M 11/02; B62M 11/10

(52) U.S. Cl. CPC B62M 6/55; B62M 9/00; B62M 11/10; B62M 11/02

(57) ABSTRACT

A drive device for an electric bicycle has a shaft and a redirecting gearbox configured for coupling with an electric motor and the shaft so that a torque is transmittable from the motor to the shaft via the gearbox. The gearbox has a first gear element rotatable about a first axis and a second gear element coupled to the first. The second gear element can rotate about a second axis running at an angle to the first axis. A torque is transmittable from the first gear element to the shaft through a coupling therebetween. The device is configured to rotate the shaft in a first rotational direction relative to the first gear element. The first gear element is axially displaceable relative to the second gear element, parallel to the first axis, within predetermined limits, the gear elements remaining coupled to one another within the predetermined limits.

### CROSS-REFERENCE TO RELATED APPLICATIONS

This application is a continuation application of international patent application PCT/EP2023/065123, filed Jun. 6, 2023, designating the United States and claiming priority from German application 10 2022 116 830.1, filed Jul. 6, 2022, and the entire content of both applications is incorporated herein by reference.

### TECHNICAL FIELD

The disclosure relates to a drive device for an electric bicycle and an electric bicycle with such a drive device.

### BACKGROUND

Bicycles are a cost-effective, easy-to-use and emission-free means of transportation. They have also found widespread use as sports and fitness equipment, and particularly suitable types have emerged for various sporting applications.

In recent years, enthusiasm for electric bicycles (especially so-called “pedelecs”) has been growing, despite the high weights and prices for bicycles. With electric bicycles, it is important to provide a reliable supportive drive system that enables high power transmission.

### SUMMARY

One task to be solved is to create a reliable drive device for electric bicycles, in particular a drive device with a simple structure in which the forces occurring are optimally supported. A further task is to provide an electric bicycle with such a drive device.

These tasks are solved, inter alia, by various embodiments of the disclosure.

First of all, the drive unit for an electric bicycle is specified.

In at least one embodiment, the drive device for an electric bicycle has a shaft and a redirecting gearbox. The redirecting gearbox configured, on the one hand, to couple with an electric motor and, on the other hand, to couple with the shaft so that a torque can be transmitted from the electric motor to the shaft via the redirecting gearbox. The redirecting gearbox has a first gear element that can rotate about a first axis and a second gear element coupled to the first gear element. The second gear element can be rotated about a second axis running at an angle to the first axis. The drive device is configured to transmit a torque from the first gear element to the shaft via a coupling between the first gear element and the shaft, and is also configured to rotate the shaft in a first rotational direction relative to the first gear element. The first gear element is also axially displaceable relative to the second gear element, parallel to the first axis, within predetermined limits, wherein the gear elements remain coupled to one another within the predetermined limits.

In particular, the present disclosure is based on the realization that, when the shaft is driven by the electric motor, a reliable coupling between the first gear element and the shaft should be ensured. On the other hand, if the shaft is not driven by the electric motor, the shaft should rotate independently of the electric motor in at least one rotational direction. In order to avoid complex axial positioning of the first gear element, in the present disclosure the first gear element is arranged to move axially, whereby the axial movement is only permitted within predetermined limits. As a result, the first gear element is optimally positioned on the one hand and, on the other hand, any forces that occur are optimally supported. Advantageously, the shaft can be rotated relative to the first gear element in the first rotational direction and is therefore decoupled from all gear stages and the electric motor with respect to this first rotational direction. As a result, the pedaling resistance is low, for example when the electric motor assistance is omitted.

For example, the shaft of the drive device is mounted so that it can rotate about an axis parallel to the first axis, in particular so that it can rotate about the first axis.

The redirecting gearbox, also known as an angular gearbox, is configured in particular to be coupled to the electric motor on the drive side and to the shaft on the output side. For example, the second gear element is configured for a (direct) coupling with the electric motor. The redirecting gearbox can be a ratio-free redirecting gearbox, that is, the outgoing speed of the redirecting gearbox is equal to the incoming speed (ratio=1). Alternatively, the redirecting gearbox can have a transmission ratio of at least a factor of 1.5 or 2, for example a factor of 5, so that the outgoing speed is not equal to the incoming speed.

The first and second gear elements of the redirecting gearbox are coupled to each other, in particular such that a torque can be transmitted from the second gear element to the first gear element and/or vice versa. For example, the coupling is such that each rotation of the second gear element about the second axis leads to a rotation of the first gear element about the first axis and/or vice versa. In particular, the gear elements are directly coupled to each other. The coupling between the first and the second gear element is realized, for example, by a toothed interface between the first and the second gear element. For example, the first and second gear elements engage directly with each other.

An interface of a coupling is understood here and in the following to mean in particular the area in which a force or torque is transmitted between two elements, such as the gear elements. This area includes, in particular, the contact points between two components that can move relative to each other and/or the intermediate area between the components that can move relative to each other.

The second axis, about which the second gear element can be rotated, runs crosswise to the first axis, about which the first gear element can be rotated. For example, the second axis intersects the first axis at one point or is skew to the first axis. The first axis and the second axis can run perpendicular to each other or at an angle of less than 90° to each other. For example, an angle between the first axis and the second axis is at least 30° or at least 45°.

The drive device is arranged to transmit a torque from the first gear element to the shaft via a coupling between the first gear element and the shaft. For example, a torque can be transmitted from the first gear element to the shaft, which supports a rotation of the shaft in the first rotational direction. In other words, at least in a first operating state of the drive device, a coupling is established between the first gear element and the shaft, via which a torque can be or is transmitted from the first gear element to the shaft. In the first operating state, for example, a rotation of the shaft in the first rotational direction is supported or caused by a rotation of the first gear element. For example, in the first operating state, the shaft and the first gear element rotate together about the first axis without rotating relative to one another, that is, at the same rotational speed or angular speed.

The drive device is also configured to rotate the shaft in the first rotational direction and relative to the second gear element. In particular, the drive device is configured such that the shaft can be rotated at least in the first rotational direction independently of the first gear element. For example, the shaft can rotate in the first rotational direction without the first gear element rotating. In other words, the drive device can be operated in a second operating state in which the shaft rotates in the first rotational direction relative to the first gear element. In the second operating state, the shaft rotates, for example, independently of the first gear element, for example by more than 360°.

The coupling between the first gear element and the shaft is in particular such that rotation of the first gear element in the first rotational direction relative to the shaft is blocked and rotation of the shaft relative to the first gear element in the first rotational direction is enabled.

The drive device is configured, for example, to switch back and forth between the first and second operating states or to be switched back and forth. Switching from the first to the second operating state and/or vice versa takes place automatically, for example. For example, switching from the first operating state to the second operating state takes place automatically if the rotational speed of the first gear element in the first rotational direction is lower than the rotational speed of the shaft in the first rotational direction. It is also possible to switch automatically from the second operating state to the first operating state if the first gear element rotates faster in the first rotational direction than the shaft.

Here and in the following, rotation of an element means rotation about the axis about which the respective element can be rotated. In other words, for the first gear element and/or the shaft, rotation means rotation about the first axis. For the second gear element, rotation means rotation about the second axis. The first rotational direction is, for example, a clockwise or counterclockwise rotation. Unless otherwise specified, rotation here and in the following also refers to rotation relative to a housing of the drive device.

The first gear element is also axially displaceable relative to the second gear element. Alternatively or additionally, the first gear element can be axially displaceable relative to the shaft. Here and in the following, unless otherwise specified, the term axial direction refers to a direction parallel to the first axis. Accordingly, the term axial refers to this first axis. Furthermore, unless otherwise specified, the azimuthal direction here and in the following refers to an azimuthal direction with respect to the first axis, that is, along a circular line around the first axis. Unless otherwise specified, radial direction here and hereinafter means a radial direction with respect to the first axis, that is, a direction perpendicular to the first axis and perpendicular to the azimuthal direction. The terms azimuthal and radial are to be understood accordingly.

The first gear element is displaceable relative to the second gear element and/or relative to the shaft within predetermined limits. This means that the first gear element can be displaced relative to the second gear element and/or relative to the shaft within a limited range or over a limited distance, for example at least 0.01 mm or at least 0.1 mm. In particular, axial displacement of the first gear element beyond these limits is blocked. A backlash between the first and second gear element is, for example, at least 0.01 mm and at most 0.1 mm.

The first and second gear elements remain coupled to each other within the specified limits. This means that the axial movement of the first gear element relative to the second gear element and/or the shaft is limited in such a way that the coupling is maintained even with maximum axial displacement/movement of the first gear element. For example, the toothed interface is always maintained during an axial movement within the specified limits.

According to at least one embodiment, the axial movement of the first gear element relative to the second gear element in a first axial direction is limited by the second gear element. Alternatively or additionally, the axial movement of the first gear element relative to the second gear element in an opposite, second axial direction is limited by a limiting means.

The limitation in the first axial direction can be realized, for example, by the first gear element striking the second gear element. Alternatively, a damping element, for example a spring, can limit the movement of the first gear element in the first axial direction. The limiting means can be a stop surface against which the first gear element strikes when moving in the second axial direction. Alternatively, the limiting means can be a damping element, for example a spring, which limits the movement of the first gear element in the second axial direction.

According to at least one embodiment, the limiting means is fixed axially to the shaft and/or axially to the second gear element. This means that at least a part of the limiting means is arranged immovably in the axial direction relative to the shaft and/or the second gear element. In addition, the limiting means can be fixed azimuthally and/or radially.

According to at least one embodiment, the drive device is configured such that an axial force acts on the first gear element when torque is transmitted from the second gear element to the first gear element. This axial force is transmitted via the limiting means, for example either to the shaft or to an element of the drive device that is fixed axially to the shaft. For example, the axial force is then absorbed, in particular completely absorbed, by the shaft or the element.

The axial force acts in particular in the second axial direction, for example in the direction away from the second gear element. The axial force can be dissipated from the limiting means in such a way that it no longer results in an axial movement of the first gear element relative to the second gear element. For example, the first gear element strikes against the limiting means and the axial force presses the first gear element against the limiting means. Because the limiting means dissipates the axial force and preferably dissipates it onto the shaft or the element, the coupling between the first gear element and the shaft for torque transmission is axially relieved. This is advantageous because many couplings for torque transmission are not configured to absorb large axial forces.

According to at least one embodiment, the drive device has at least one bearing. With the aid of the bearing, the first gear element is mounted rotatably about the first axis relative to the shaft. The bearing can be a roller bearing, in particular a cylinder roller bearing or a ball bearing. The bearing can be an element separate from the shaft and the first gear element, which is arranged between the shaft and the first gear element, for example radially between the first gear element and the shaft. Alternatively, the shaft and/or the limiting means and/or the first gear element can be part of the bearing. For example, the shaft forms the inner ring of the bearing and/or the first gear element forms the outer ring of the bearing or vice versa.

According to at least one embodiment, an interface of the coupling between the first gear element and the shaft is arranged axially between two bearings. Each of these bearings can be formed like the aforementioned bearing.

The coupling between the first gear element and the shaft can be realized by a mechanical interface at which two elements for torque transmission touch each other (for example in the area of contact points). The coupling interface can then be a toothed interface. Alternatively, the coupling can also be an electromagnetic coupling, for example, in which the torque is transmitted by magnetic forces, in particular without direct contact.

The coupling between the first gear element and the shaft can be achieved, for example, via a clutch of the drive device. In particular, the clutch can be arranged axially between the two bearings. The clutch can also be formed as a unit with the bearing or bearings. The clutch can be a separate element from the first gear element and the shaft. Alternatively, the first gear element and/or the shaft can be part of the clutch.

In the present application, the term “coupling” refers to the state of being coupled, whereas the term “clutch” refers to the concrete means for producing the coupling.

According to at least one embodiment, the coupling between the first gear element and the shaft is a freewheel coupling, also known as an overrunning coupling. Accordingly, the clutch can be a freewheel clutch or overrunning clutch. The freewheel clutch is, for example, a sprag-type freewheel clutch or a sleeve-type freewheel clutch.

According to at least one embodiment, the redirecting gearbox is a bevel gearbox. The first gear element is then, for example, a ring gear and the second gear element is a bevel pinion.

According to at least one embodiment, the redirecting gearbox has a transmission ratio of at least 2 or at least 4. Alternatively or additionally, the transmission ratio is at most 8 or at most 6. For example, the transmission ratio is at least 5 and at most 6.

The redirecting gearbox and the bearing of the first gear element are selected in particular in such a way that the radial force F_R transmitted from the second to the first gear element results in a frictional force F_RE for an axial displacement of the first gear element relative to the second gear element that is smaller than the axial force F_A transmitted from the second to the first gear element. The following therefore applies: F_RE<FA. As a result, when the second gear element rotates, the first gear element is axially displaced and pressed against the limiting means, for example.

According to at least one embodiment, the interface of the coupling between the ring gear and the bevel pinion is tilted by a tilt angle with respect to the first axis. This tilt angle is also referred to as the bevel angle. The tilt angle is, for example, at least 45° or at least 60°. The angle of the interface with respect to the first axis corresponds in particular to the angle of the lateral surface of the conical pinion with respect to the first axis. In particular, the resultant force includes, for example, an angle of at least 45° or at least 60° with the first axis.

A tilting angle of at least 45° is advantageous in that the radial force component transmitted to the first gear element is relatively low and the radial force acting on the bearings or the coupling can therefore be kept low. The axial force is dissipated by the limiting means.

According to at least one embodiment, the shaft is a chainring shaft, that is, a shaft on which a chainring is mounted or can be mounted. In particular, the shaft is a hollow shaft.

According to at least one embodiment, the limiting means is a stop surface. For example, the stop surface is axially fixed to the second gear element and/or to the shaft. The stop surface can be a surface of the shaft or of an element that is fixed axially to the shaft, for example. For example, the stop surface is fixed axially, radially and azimuthally to the shaft, that is, in particular immovable relative to the shaft.

According to at least one embodiment, a further stop surface is assigned to the first gear element. The further stop surface is, for example, fixed axially and/or radially and/or azimuthally to the first gear element, that is, in particular arranged immovably relative to the first gear element. For example, the further stop surface is a surface of the first gear element.

According to at least one embodiment, the stop surfaces face each other in the axial direction. For example, the stop surfaces overlap radially and azimuthally with one another, that is, they overlap in the radial direction and azimuthal direction. In addition, the stop surfaces preferably face each other.

The fact that two elements overlap in one direction means that the coordinates of the two elements have an overlapping value range for this direction. In other words, the elements are then aligned with each other in this direction.

According to at least one embodiment, the stop surfaces are arranged to strike against each other to limit the axial movement of the first gear element. This means that the axial movement of the first gear element in the second axial direction relative to the second gear element is limited by the further stop surface striking against the stop surface. The stop surface and the other stop surface come into direct contact with each other during the strike.

According to at least one embodiment, the stop surfaces are positioned axially between the second gear element and the interface of the coupling between the first gear element and the shaft. In particular, the stop surfaces are therefore positioned axially between the second gear element and the clutch.

According to at least one embodiment, the area in which the stop surfaces strike against each other is radially offset in relation to the first axis with respect to the interface of the coupling between the first gear element and the shaft or to the clutch. For example, the interface of the coupling and the area in which the stop surfaces strike against each other do not overlap radially. However, the area and the interface can overlap azimuthally. For example, the area is offset radially inwards relative to the interface or the clutch.

According to at least one embodiment, the stop surfaces are metallic, for example made of aluminum or stainless steel.

According to at least one embodiment, a lubricant is applied to the stop surfaces. The lubricant facilitates relative rotation between the stop surfaces about the first axis.

According to at least one embodiment, the first gear element radially surrounds the shaft partially or completely.

According to at least one embodiment, the interface of the coupling between the first gear element and the shaft is arranged in the radial direction between the shaft and the first gear element. In the axial direction, the interface can be arranged overlapping with the first gear element and the shaft. For example, the clutch is arranged radially between the first gear element and the shaft and axially overlapping with the shaft and the first gear element.

Next, the electric bicycle is specified. The electric bicycle is a so-called Pedelec, for example.

In at least one embodiment, the electric bicycle includes a drive device according to one of the embodiments described herein. In addition, the electric bicycle includes an electric motor, wherein the electric motor is coupled to the redirecting gearbox so that a torque of the electric motor is transmitted to the first gear element via the second gear element. Furthermore, the electric bicycle can have control electronics to control the electric motor.

### BRIEF DESCRIPTION OF DRAWINGS

The invention will now be described with reference to the drawings wherein:

FIG. 1 shows an embodiment of an electric bicycle;

FIG. 2 is a cross-sectional view of an embodiment of the drive device;

FIG. 3 shows an enlarged section of the embodiment of FIG. 2; and,

FIGS. 4 and 5 show the embodiment of the drive device of FIG. 2 in different operating states.

### DETAILED DESCRIPTION

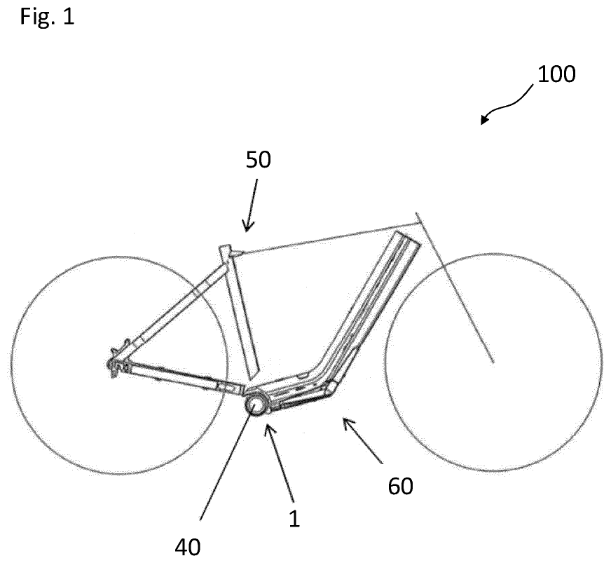

FIG. 1 schematically shows an electric bicycle 100 with a bicycle frame 50, which, among other things, has a lower frame section 60, which forms a down tube. The frame section 60 extends in the direction of a bottom bracket, which includes a pedal crank 40, which is connected to a drive device 1 for the electric bicycle 100 is coupled or can be coupled. The drive device 1 is coupled or can be coupled to an electric motor. The electric motor is arranged here, for example, in the down tube of the frame 50. Alternatively, the electric motor could also be arranged in the seat tube.

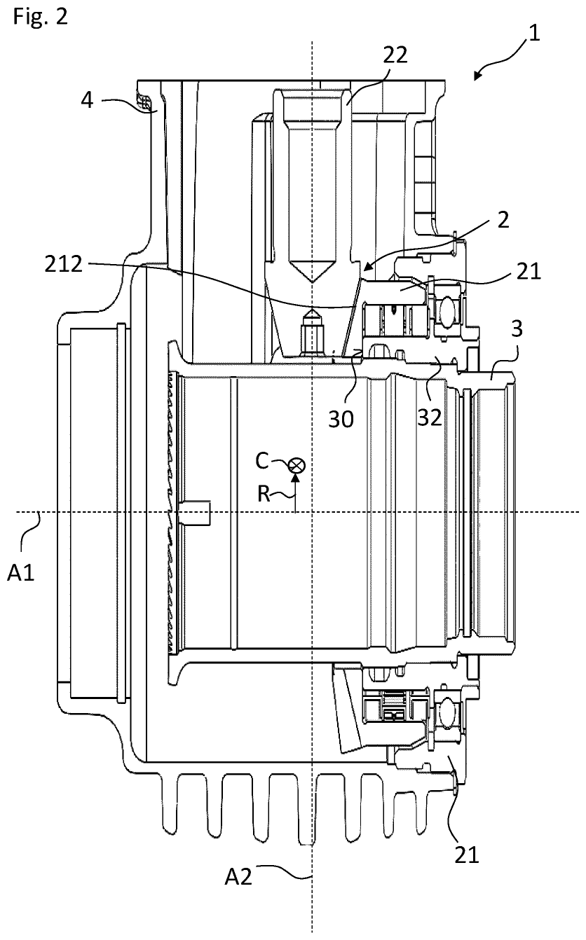

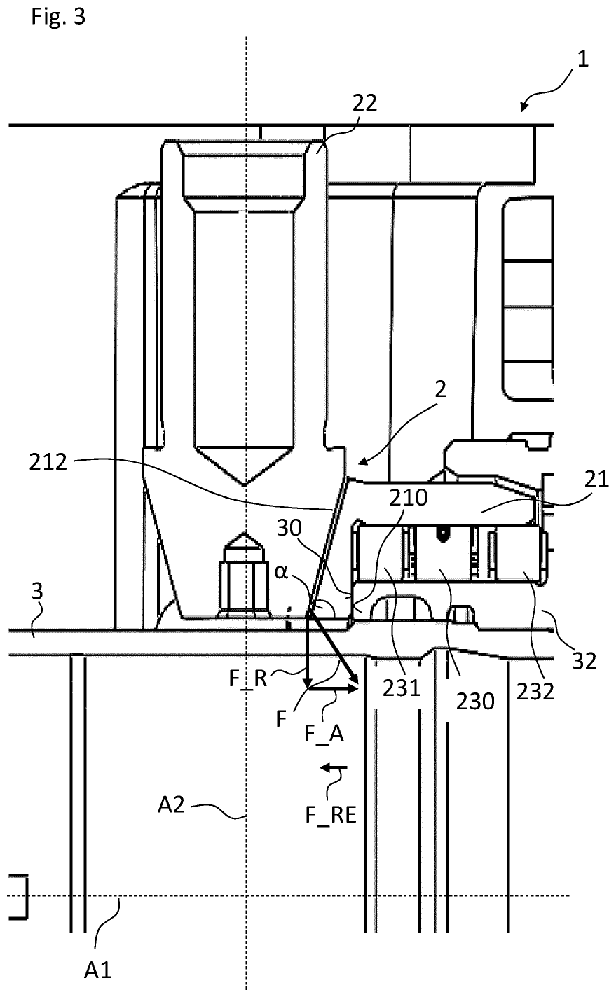

FIG. 2 shows a cross-sectional view of an embodiment of the drive device 1. For example, this is the drive device 1 shown in FIG. 1. FIG. 3 shows an enlarged section of FIG. 2.

The drive device 1 includes a housing 4. A redirecting gearbox 2 is arranged inside the housing 4. The redirecting gearbox 2 includes a first gear element 21 and a second gear element 22. In the present case, the redirecting gearbox 2 is a bevel gearbox. The first gear element 21 is a ring gear and the second gear element 22 is a bevel pinion.

FIG. 2 also shows axes A1 and A2. The ring gear 21 is rotatably mounted (relative to the housing 4) about the first axis A1, the bevel pinion 22 is rotatably mounted (relative to the housing 4) about the axis A2. The axes A1 and A2 are perpendicular to each other. FIG. 2 also shows a radial direction R and an azimuthal direction C in relation to the first axis A1. The radial direction R is a direction perpendicular to the first axis A1 and the azimuthal direction C is a direction around the axis A1. In the illustration in FIG. 2, the azimuthal direction C points in the paper plane.

The ring gear 21 surrounds a shaft 3 of the drive device 1 in the radial direction R. The shaft 3 is also rotatably mounted about the axis A1. The shaft 3 is a hollow shaft. The shaft 3 is guided out of the housing 4 and can be connected to a chain ring.

The drive device 1 of FIG. 2 is configured such that the bevel pinion 22 is couplable to an electric motor for the electric bicycle. A rotational direction of the rotor of the electric motor can run parallel to the axis A2 and/or parallel to the longitudinal axis of the down tube.

The bevel pinion 22 is driven by the energy provided by the electric motor, namely it rotates about the second axis A2. The bevel pinion 22 is coupled to the ring gear 21 via an interface 212. The interface 212 is a toothing interface. Due to the coupling via the interface 212, a rotation of the bevel pinion 22 leads to a rotation of the ring gear 21 about the first axis A1.

A clutch 230 is provided between the ring gear 21 and the shaft 3 (see FIG. 3). In the present case, the clutch 230 is, for example, a freewheel clutch. However, another mechanical clutch or an eddy current clutch could also be used.

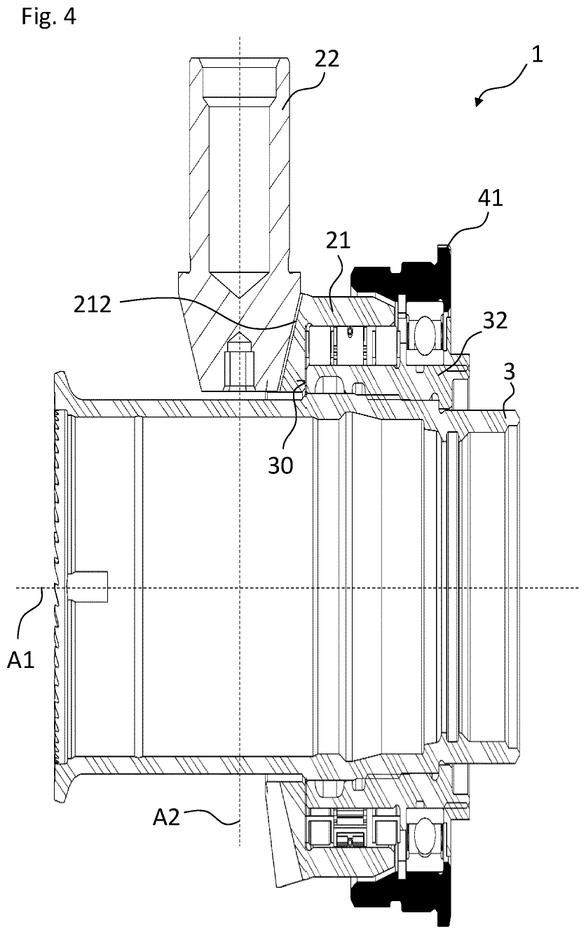

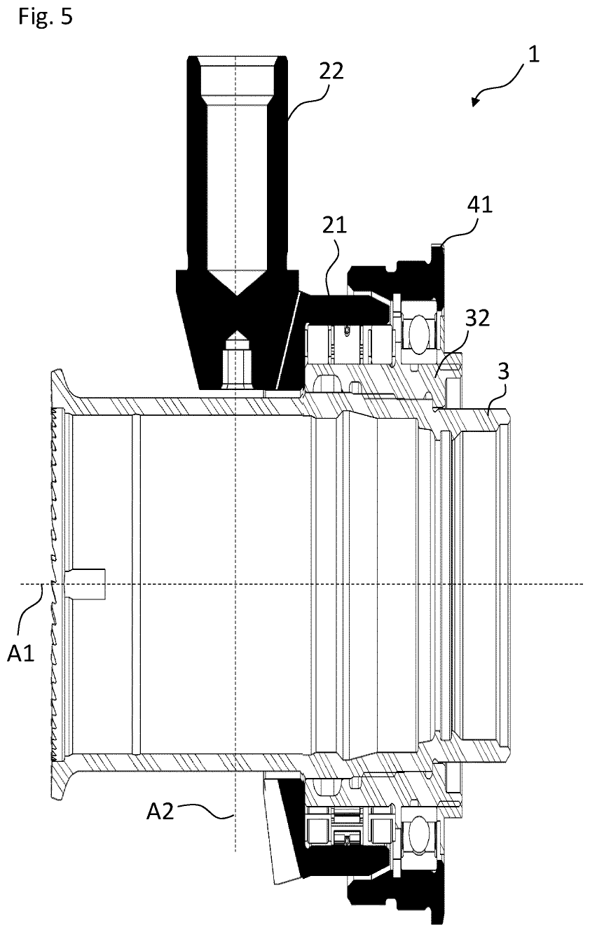

The freewheel clutch allows the shaft 3 to rotate in a first rotational direction, for example clockwise or counterclockwise, relative to the ring gear 21. Conversely, the ring gear 21 cannot rotate relative to the shaft 3 in the first rotational direction. The ring gear 21 can maximally rotate together with the shaft, that is, at the same speed as the shaft 3, in the first rotational direction. In this case, a torque is transmitted via a coupling between the ring gear 21 and the shaft 3, provided by the clutch 230, from the ring gear 21 to the shaft, the torque supporting the rotation. This is explained in more detail in connection with FIGS. 4 and 5.

FIG. 4 shows the drive device 1 in a first operating state, in which all the elements shown rotate except for the black-colored element 41. The element 41 is a housing element of the housing 4. The rest of the housing 4 is omitted for reasons of clarity.

In the first operating state, the bevel pinion 22 rotates about the second axis A2. A torque is transmitted to the ring gear 21 at the interface 212, forcing it to rotate about the first axis A1 in the first rotational direction. A torque is transmitted from the ring gear 21 to the shaft 3 by the freewheel clutch 230 so that the shaft 3 rotates at the same rotational speed in the first rotational direction about the first axis A1 as the ring gear 21. This first operating state is therefore in particular the state in which the electric motor transmits an assisting torque to the shaft 3. For example, this first operating state is set when the electric bicycle is traveling below a predetermined maximum speed, such as 25 km/h, and the rider is pedaling. These two conditions are detected by sensors on the electric bicycle, for example.

FIG. 5 shows the drive device 1 in a second operating state. Again, the black colored elements are those that do not rotate. In this case, only the shaft 3 rotates in the first rotational direction about the first axis A1. The bevel pinion 22 and the ring gear 21 do not rotate. This means that the shaft 3 rotates relative to the ring gear 21 in the first rotational direction, which is made possible by the freewheel clutch 230 between the ring gear 21 and the shaft 3. This second operating state corresponds, for example, to the operating state in which the electric motor is switched off or the electric bicycle exceeds the predetermined maximum speed.

In order to facilitate the rotation of the shaft 3 relative to the ring gear 21 in the second operating state, to define a specific height for the freewheel, to absorb radial forces and to hold the ring gear 21 in position, the drive device 1 includes two bearings 231, 232 (see FIG. 3). The freewheel clutch 230 is arranged axially, in the direction parallel to the first axis A1, between the two bearings 231, 232. The bearings 231, 232 are rolling bearings, for example ball bearings.

In the drive device 1 of the embodiment shown in FIGS. 2 to 5, the ring gear 21 is arranged to move axially relative to the shaft 3 and the bevel pinion 22, namely within predetermined limits. On the one hand, the axial movement of the ring gear 21 in a first axial direction, namely towards the bevel pinion 22, is limited by striking against the bevel pinion 22. In the opposite, second axial direction, the movement of the ring gear 21 is limited by striking against a limiting means 30 in the form of an stop surface 30. The stop surface 30 is part of an element 32 that is axially fixed to the shaft 3. However, the stop surface 30 could also be part of the shaft 3, that is, formed integrally or in one piece with the shaft 3.

The ring gear 21 has a further stop surface 210, which faces the stop surface 30 and overlaps both radially and azimuthally with the stop surface 30. The stop surfaces 30 and 210 are made of metal, for example, and are covered with a lubricant.

One advantage of limiting the axial movement of the ring gear 21 with the aid of the stop surface 30 becomes clear when you look at the force diagram in FIG. 3. When the ring gear 21 is driven by the bevel pinion 22, a force F is transmitted to the ring gear 21 at the interface 212. This force F is divided into a radial component F_R and an axial component F_A. During driving, the ring gear 21 is therefore pressed against the stop surface 30 in the axial direction with its other stop surface 210. The axial force F_A is transferred to the shaft 3 via the stop surface 30. In particular, the axial force F_A is greater than a frictional force F_RE caused by the radial force F_R, which acts against a displacement of the ring gear 21 along the axis A1.

Without this stop surface 30, the axial force F_A would be transferred to the bearings 231, 232 and/or the one-way clutch 230. However, these elements are often not configured to absorb large axial forces and could be damaged by such forces. In this respect, the stop surface 30 or the limitation of the freedom of movement of the ring gear 21 in the axial direction increases the service life of the drive device 1.

The axial mobility of the ring gear 21 is also advantageous in the second operating state, in which the shaft 3 rotates relative to the ring gear 21. In this operating state, for example, the bevel pinion 22 is not driven so that no axial force F_A presses the ring gear 21 against the stop surface 30. The ring gear 21 can move at least a little away from the stop surface 30. This allows the two stop surfaces 30, 210 to slide past each other relatively friction-free. This can be further improved by the lubricant provided on the stop surfaces 30, 210 or the lubricant between them.

It is clear from the explanations given that the axial displaceability of the ring gear 21 relative to the bevel pinion 22 or relative to the shaft 3 is advantageous compared to axial fixing of the ring gear 21. In addition, axial fixing of a ring gear 21 is very complex and is advantageously avoided here.

Furthermore, as can be seen from FIG. 3, the bevel gear 2 of the present drive device 1 is configured such that the interface 212 between the bevel pinion 22 and the ring gear 21 is tilted with respect to the axis A1 such that the tilting angle α between the interface 212 and the axis A1 is at least 45°.

The arrangement of the stop surfaces 30, 210 axially between the one-way clutch 230 or the bearings 231, 232 and the bevel pinion 22 is advantageous with regard to possible tilting between the ring gear 21 and the bevel pinion 22. The risk of tilting between the bevel pinion 22 and the ring gear 21 is additionally reduced by the fact that the second bearing 232 is used.

It is understood that the foregoing description is that of the preferred embodiments of the invention and that various changes and modifications may be made thereto without departing from the spirit and scope of the invention as defined in the appended claims.

### LIST OF REFERENCE SIGNS

1 drive device
2 redirecting gearbox
3 shaft
4 housing
21 first gear element
22 second gear element
30 limiting means
32 element
40 pedal crank
41 housing element
50 bicycle frame
60 frame section
100 electric bicycle
210 further stop surface
212 interface
230 clutch
231 bearing
232 bearing
A1 first axis
A2 second axis
R radial direction
C azimuthal direction
F force
F_R radial component of the force
F_A axial component of the force
F_FE frictional force
α tilt angle

1-15. (canceled)

16. A drive device for an electric bicycle, the drive device comprising:
a shaft;
a redirecting gearbox for coupling with an electric motor and said shaft so that a torque is transmittable from the electric motor via said redirecting gearbox to said shaft;
said redirecting gearbox having a first gear element rotatable about a first axis and a second gear element coupled to said first gear element, said second gear element being rotatable about a second axis running at an angle to the first axis;
the drive device being configured to transmit a torque from said first gear element to said shaft via a coupling between said first gear element and said shaft;
the drive device being further configured to rotate said shaft in a first rotational direction relative to said first gear element; and,
said first gear element being axially displaceable relative to said second gear element, parallel to the first axis, within predetermined limits, wherein said first gear element and said second gear element remain coupled to one another within the predetermined limits.

17. The drive device of claim 16, wherein:
an axial movement of said first gear element is limited in a first axial direction by said second gear element and in an opposite, second axial direction by a limiter; and,
said limiter is axially fixed to at least one of said shaft and said second gear element.

18. The drive device of claim 17, wherein the drive device is configured such that, when a torque is transmitted from said second gear element to said first gear element, an axial force acts on said first gear element and this axial force is dissipated via said limiter onto said shaft or an element fixed axially to said shaft.

19. The drive device of claim 16 further comprising:
at least one bearing; and,
said first gear element being mounted to said shaft via said at least one bearing.

20. The drive device of claim 19, wherein an interface of said coupling between said first gear element and said shaft is arranged axially between two of said at least one bearing.

21. The drive device of claim 16, wherein said coupling between said first gear element and said shaft is a freewheel coupling.

22. The drive device of claim 16, wherein said redirecting gearbox is a bevel gearbox, in which said first gear element is a ring gear and said second gear element is a bevel pinion.

23. The drive device of claim 16, wherein said redirecting gearbox has a transmission ratio of at least 4 and at most 6.

24. The drive device of claim 16, wherein said shaft is a chainring shaft.

25. The drive device of claim 17, wherein:
said limiter is a stop surface;
a further stop surface is assigned to said first gear element and is axially fixed to it;
said stop surface and said further stop surface lie opposite each other in an axial direction, overlap radially and azimuthally and face each other; and,
said stop surface and said further stop surface are arranged to strike against each other to limit an axial movement of said first gear element.

26. The drive device of claim 25, wherein said stop surface and said further stop surface are positioned axially between said second gear element and an interface of said coupling between said first gear element and said shaft.

27. The drive device of claim 25, wherein an area in which said stop surface and said further stop surface strike against one another is radially offset relative to an interface of said coupling between said first gear element and said shaft.

28. The drive device of claim 25, wherein:
said stop surface and said further stop surface are metallic; and,
a lubricant is applied to said stop surface and said further stop surface.

29. The drive device of claim 16, wherein:
said first gear element at least partially radially surrounds said shaft; and,
an interface of said coupling between said first gear element and said shaft is arranged in a radial direction between said shaft and said first gear element and is arranged overlapping in an axial direction with said first gear element and said shaft.

30. An electric bicycle comprising:
an electric motor;
a drive device having a shaft and a redirecting gearbox;
said redirecting gearbox being for coupling with said electric motor and said shaft so that a torque is transmittable from said electric motor via said redirecting gearbox to said shaft;
said redirecting gearbox having a first gear element rotatable about a first axis and a second gear element coupled to said first gear element, said second gear element being rotatable about a second axis running at an angle to the first axis;
said drive device being configured to transmit a torque from said first gear element to said shaft via a coupling between said first gear element and said shaft;
said drive device being further configured to rotate said shaft in a first rotational direction relative to said first gear element;
said first gear element being axially displaceable relative to said second gear element, parallel to the first axis, within predetermined limits, wherein said first gear element and said second gear element remain coupled to one another within the predetermined limits; and,
said electric motor being coupled to the redirecting gearbox so that the torque of said electric motor is transmitted to said first gear element via said second gear element.
